(19) United States
(12) Patent Application Publication
(10) Pub. No.: US 2002/0115429 A1
(43) Pub. Date: Aug. 22, 2002

(54) Wireless voicemail forwarding of a truncated call

(76) Inventors: Michael J. Deluca, Boca Raton, FL (US); Noah P. Orlen, Boca Raton, FL (US)

Correspondence Address: CLARITI TELECOMMUNICATIONS INTERNATIONAL, LTD., INTELLECTUAL PROPERTY DEPARTMENT, ATTN: MICHAEL J. DELUCA, 1920 CORPORATE DRIVE, BOYNTON BEACH, FL, 33426, US

(21) Appl. No.: 09/785,788

(22) Filed: Feb. 16, 2001

(51) Int. Cl. H04Q 7/20

(52) U.S. Cl. 455/413; 455/517; 455/417

(57) ABSTRACT

A communication system has a 2-way wireless voice network such as a Bluetooth or cellular network and a 1-way wireless voice network such as the ClariCAST™ network. A wireless device has both a 2-way transceiver for completing voice calls and a 1-way receiver for receiving voicemail. If a 2-way call is truncated, then the caller is forwarded to a voicemail system. The voicemail is then transmitted to the wireless device over the 1-way network. If the wireless device connects to the voicemail server while the caller is connected to the voicemail system then the coupling between the caller and the wireless device is re-established.

### FIELD OF THE INVENTION

This invention is related to field of wireless communication devices and voicemail.

### BACKGROUND OF THE INVENTION

Digital voice messaging, such as the ClariCAST™ system and Voca™ wireless voicemail receiver manufactured and distributed by Clariti™ Telecommunications International facilitates the adoption of low cost wide area one-way voice communication. In one application of this system, voice messages received by a voicemail server are digitized and transmitted using FM SCA spectrum. The system has the advantage of providing large coverage areas with sufficient capacity to communicate digitized voice messages to wireless receivers.

Cellular and PCS systems have proliferated the use of wireless telephones. The advent of third generation cellular telephone systems and the potential of Bluetooth based two-way communication systems will further the adoption of such wireless devices. Such systems, while advantageously enabling two-way voice conversations, have the disadvantage of call truncation. Call truncation may be due to the wireless device traveling beyond a limited coverage area of the two-way network. Also, the truncation may be due to insufficient network capacity to handle the conversation, or a failed handoff. Alternately, the call may be truncated intentionally because, for example the user is in a heavy automobile traffic environment requiring full attention. Thus, what is needed is a communication system having the advantages of wide area one-way voicemail messaging of the ClariCAST™ system and two-way voice communication while addressing disadvantages of call truncation of two-way communication systems.

### BRIEF DESCRIPTION OF THE DRAWINGS

FIG. 1 shows a block diagram operating in accordance with the present invention.

FIG. 2 shows a flow diagram of a process operating in accordance with the present invention.

### DETAILED DESCRIPTION OF THE INVENTION

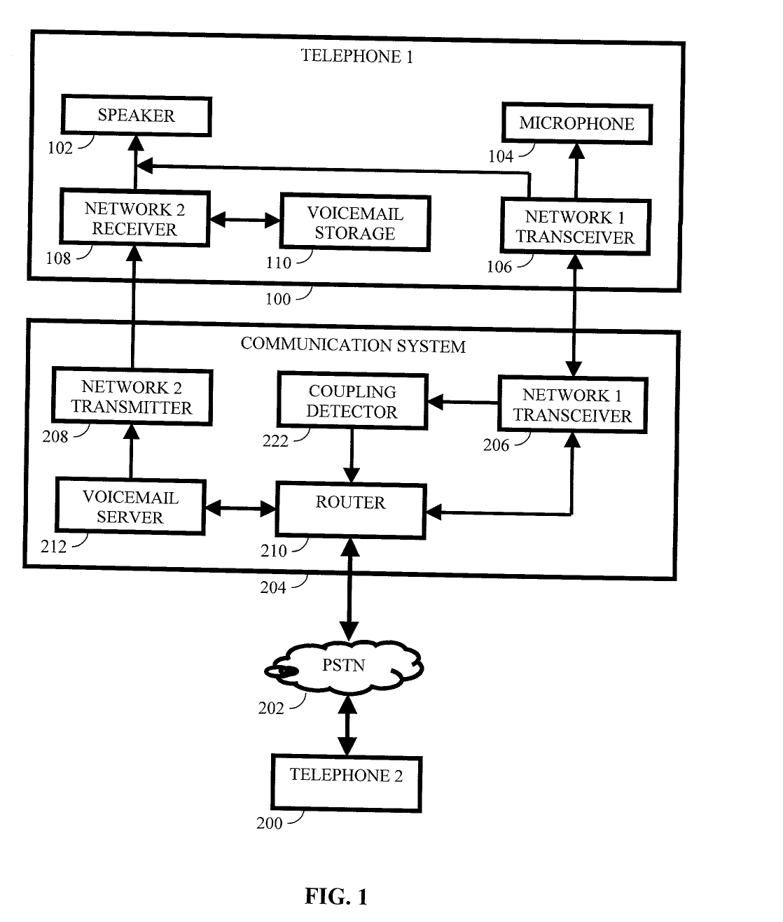

FIG. 1 shows a block diagram operating in accordance with the present invention. A first wireless telephone 100 had a speaker 102 and microphone 104 for communicating audio messages with a user of the telephone. Network 1 transceiver 106 is a two-way transceiver for coupling the telephone to and communicating through a first network. Not shown are the other control, power and user interface components ordinarily found in wireless telephones and known to those familiar with the art. The telephone also has a second network receiver 108 for receiving voicemail messages and storing the voicemail message in a storage memory 110. The voicemail messages are presented to speaker 102 to be heard by the user. Speaker 102 is shared by both network 1 and network 2 receivers. While the second network receiver is preferably a ClariCAST™ receiver and signal processor, it should be appreciated that the second network receiver could operate on other one-way networks. Alternately, receiver 108 could be part of a second transceiver operating on a second two-way network different from the first two-way network of transceiver 1. Still further, receiver 108 and voicemail storage 110 need not be integrated into telephone 100 and may alternately be incorporated into a separate device such as the Voca™ voicemail player.

The first telephone is coupled to the second telephone 200 through the Public Switched Telephone Network 202 (PSTN) and communication system 204. Communication system 204 includes two wireless networks. The system communicates through the first wireless network through network 1 transceiver 206 which wirelessly couples to transceiver 106. The system communicates through the second wireless network through network 2 transmitter 208 which wireless couples to receiver 108. The communication system 204 has a router 210 which couples communications from telephone 200 to either network transceiver 206 or voicemail server 212 in response to inputs including inputs from coupling detector 222. Voicemail messages stored in voicemail server 212 are coupled to network transmitter 208 for reception by network receiver 108 to be stored in voicemail storage 110 and annunciated through speaker 102. Voicemail messages in voicemail server 212 may also be accessed by the user of telephone 100 through the first wireless network or through the PSTN in a manner known to those familiar with the art.

The first wireless network implementation, including transceivers 106 and 206, includes any 2-way communication system. The preferred system is a Bluetooth communication system, but other systems such as cellular, PCS, PHS, third generation (3G) are also contemplated. The first network enables 2-way voice communication and may use circuit switch or packet switch technology communicating digital or analog voice signals as appropriate. Such systems have the ability to truncate telephone calls without the consent of both parties. Coupling detector 222 determines if a call has been truncated. Reasons for truncation include the user of the first telephone traveling outside the wireless coverage area of the first network during a call, inadequate network capacity to maintain the call and dropped calls due to failed handoffs between transceivers of the first network. Another source of truncation includes the user of the first telephone terminating the call contrary to the desires of the user of the second telephone, in this example, the first network can also be a convention plain old telephone system (POTS) network.

The second wireless network implementation, including transmitter 208 and receiver 108, is includes any 1-way or any 2-way communication system exclusive of the first network. In the preferred embodiment the second wireless network is the ClariCAST™ 1-way digital voice communication network. When combined with the Bluetooth 2-way network, the ClariCAST™ large 1-way coverage complements the relatively small Bluetooth 2-way coverage area. Both networks have the advantage of low power and low cost portable RF components, very low cost spectrum, and minimized antenna citing/zoning issues.

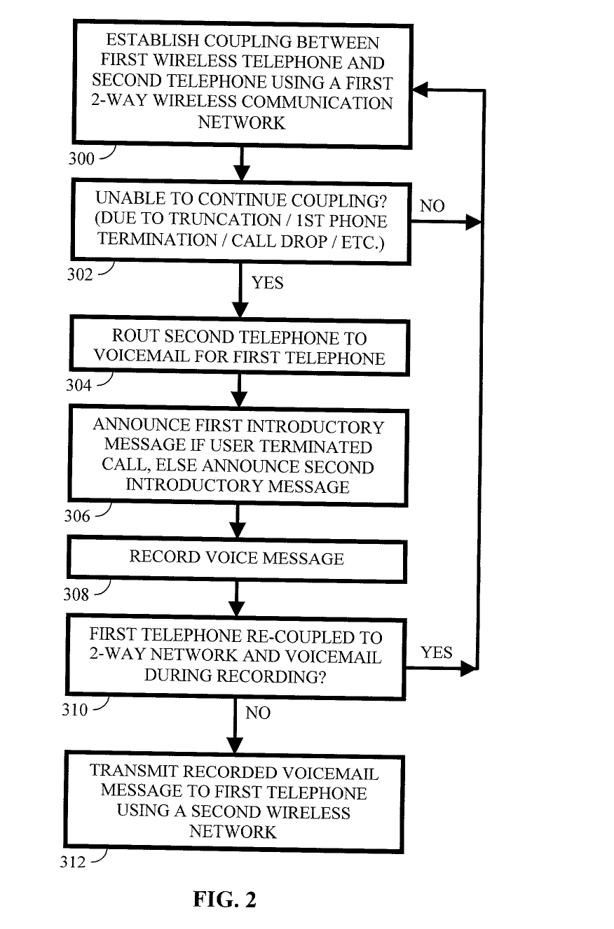

FIG. 2 shows a flow diagram of a process operating in accordance with the present invention. At step 300 a call is established between the first and second telephones using the first 2-way wireless communication system. Methods for establishing the call are well known to those familiar with the art and typically involves a user of the first telephone dialing the telephone number of the second telephone, the second telephone ringing, and the user of the second telephone answering the telephone in response thereto. Alternately, the user of the second telephone dials the telephone number of the first telephone, the first telephone rings, and the user of the first telephone answers the telephone in response thereto. Voice conversation is then initiated between the users. Step 302 determines if the coupling between the first telephone and the first 2-way network is unable to continue: an example determination includes an absence of a usable connection between the 2-way network and the wireless telephone. The truncation may be in response to an intentional act by the user of the first telephone to end the call, for example the user “hangs up” the phone by pushing an appropriate button on the telephone. This may be done if the first user is driving in heavy traffic warranting full attention. Alternately the call be truncated if the user travels beyond the range of the 2-way network, the call is dropped during a handoff between transceivers of the 2-way network, or the 2-way network has insufficient capacity to continue the coupling. If the truncations is determined, step 304 routes the second telephone to the voicemail server for voicemail associated with the first telephone. Step 304 may include a delay prior to routing to determine if and allow for the user of the second telephone 200 to terminate the coupling between telephone 200 and communication system 204. If the coupling is maintained, in step 306 the voicemail server annunciates an introductory message prior to recording a voicemail message at step 308. If the user of the first phone intentionally ended the call, then a first introductory message is selected. An example of the first introductory message is “I am unable to finish our conversation, please windup your conversation after the tone”. An example of the second introductory message is “Sorry, there's a technical difficulty with the system, please complete our conversation with a voicemail message—it will automatically be sent to my telephone. I will contact you later.” The second introductory message is preferably selected in the event of an unintentional truncation of the coupling. Note that in alternate embodiments a single introductory message may be played, or the router may not couple the message to the voicemail recorder in the event of an intentional truncation. While the second telephone is coupled to the voicemail system, step 310 checks if the first telephone has recoupled to the 2-way network and voicemail. If so, then the couple between the first and second telephones is re-established. If not, then the voicemail message is transmitted to the first telephone using the second network.

In an example of the operation of the invention, the first and second users are having a conversation. The call is dropped and the second user is coupled to the first user's voicemail system to windup the conversation with a voicemail. If the first user dials the voicemail while the second user is interfacing to the voicemail, then the coupling between the two users is re-established and they may resume their conversation. If the first user does not contact voicemail, then the voicemail is transmitted to the first telephone over a second wireless network, such as the ClariCAST™ wireless voicemail network. In this manner the user can determine the urgency of returning the call. Since the second network is independent of the first network, if the call is unintentionally truncated due to an issue with the first network, it is likely that communication of the voicemail may be successful over the second network.

In an alternate embodiment the 2-way network is a packet switched network such as the Internet and the coupling include a Voice Over Internet Protocol (VOIP) voice conversation. In this embodiment the coupling detector detects the quality of service of the VOIP coupling. Quality of service is related to the bandwidth available for the coupling and includes factors such as minimum bandwidth guarantee, packet delay, dropped packets, and network congestion. Determination of the quality of service is known to those familiar with the art. In this embodiment, if the quality of service degrades to an unacceptable level, then conversation is routed to the voicemail server and ultimately through the ClariCAST™ system.

Thus, what is provided is a communication system having the advantages of wide area one-way voicemail messaging of the ClariCAST™ system and two-way voice communication while addressing disadvantages of call truncation of two-way communication systems.

We claim:

1. In a communication system for facilitating a 2-way voice call between a first telephone and a second telephone, a device comprising:
a coupling detector for generating a truncation signal in response to detecting an absence of a continued coupling between the first telephone and the second telephone through a 2-way network of the communication system; and
a router for routing the second telephone to a voice message recorder in response to the truncation signal.

2. The device according to claim 1 further comprising
a voicemail server having the voice message recorder and coupled to said router for recording a voice message from the second telephone in response to the truncation signal.

3. The device according to claim 2 wherein
said coupling detector further detects a re-established coupling between the first telephone and the 2-way network while the second telephone is routed to said voicemail server, and
said router re-couples the first telephone to the second telephone in response thereto.

4. The device according to claim 2 wherein
said router determines if the 2-way voice call was truncated in response to a user input at the first telephone and
said voicemail server selectively announces a first or a second introductory message prior to recording the voice message wherein the first introductory message is announced in response to the determination that the call was truncated in response to the user input at the first telephone and the second introductory message is announced otherwise.

5. The device according to claim 2 wherein the 2-way voice network includes a 2-wireless network having a first coverage area and the device further comprising:
a second wireless network coupled to said voicemail server for transmitting the voice message, said second wireless network has a second coverage area different from the first coverage area of the 2-way wireless network.

6. The communication system according to claim 5 further comprising:
a first 2-way transceiver incorporated with the first telephone for coupling the first telephone to the 2-way wireless network; and
a second receiver incorporated within the first telephone for receiving the voicemail message transmitted by the second wireless network.

7. The device according to claim 1 wherein the 2-way voice network includes a 2-wireless network having a coverage area and
said coupling detector generates the truncation signal in response to an inability to continue wirelessly coupling between the first telephone and the 2-way wireless network because the first telephone travels out of range of the coverage area of the 2-way wireless network.

8. The device according to claim 1 wherein said coupling detector generates the truncation signal in response to an inability to continue coupling between the first telephone and the second telephone because of an insufficient capacity of the 2-way network.

9. The device according to claim 1 wherein the 2-way network includes a packet switched network for communicating the 2-way voice call said coupling detector determines a quality of service related to the coupling between the first and second telephones and generates the truncation signal in response to an unacceptable quality of service.

10. The device according to claim 1 wherein said router delays a predetermined time prior to coupling the second telephone to the voice message recorder, thereby providing an opportunity for termination of the call by the second telephone prior to coupling to the voice message recorder.

11. A method of communicating a message comprising the steps of:
coupling a first telephone to a communication network to establish a 2-way voice call between the first telephone and a second telephone;
determining an inability of said step of coupling to continue coupling the first telephone to the second telephone; and
routing the second telephone to a voice message recorder to record a voice message from the second telephone in response to said step of determining.

12. The method according to claim 11 wherein the first telephone is a portable wireless telephone for coupling to the communication network through a first wireless network, the portable wireless telephone further having a receiver for receiving information transmitted on a second wireless network, the method further comprising the step of
transmitting the recorded voice message to the first telephone using the second wireless network.

13. The method according to claim 12 wherein said step of determining determines the inability of said step of coupling to continue coupling the first telephone to the communication network in response to the first telephone traveling out of range of the first wireless network.

14. The method according to claim 11 wherein the first telephone is a portable wireless telephone for coupling to the communication network through a first wireless network, wherein said step of determining determines the inability of said step of coupling to continue coupling the first telephone to the communication network in response to the first telephone traveling out of range of the first wireless network.

15. The method according to claim 14 wherein the first wireless network is a Bluetooth network.

16. The method according to claim 11 wherein the first telephone is a portable wireless telephone for coupling to the communication network through a first wireless network, wherein said determining determines the inability of said step of coupling to continue coupling the first telephone to the communication network in response to insufficient capacity of the first wireless network to continue coupling to the first telephone.

17. The method according to claim 11 further comprising the steps of:
re-establishing connection between the first telephone and the communication network; and
re-routing the second telephone to the first telephone in response to said steps of routing and re-establishing.

18. The method according to claim 11 wherein the communication network includes a packet switched network for communicating the 2-way voice call wherein said step of determining determines a quality of service related to the 2-way voice call and generates the truncation signal in response to an unacceptable quality of service.

19. In a communication system for facilitating a 2-way voice call with a second telephone comprising:
a first portable wireless telephone having
a first transceiver operating on a first wireless network; and
a receiver operating on a second wireless network; and
a device comprising
another transceiver operating on the first wireless network;
a transmitter operating on the second wireless network:
a voicemail server for recording the voice message;
a coupling detector for generating a truncation signal in response to detecting an absence of a continued coupling between the first telephone and the device through the first wireless network; and
a router for routing the second telephone to said voicemail server in response to the truncation signal, wherein
said voicemail server records a voicemail message from the second telephone in response to the truncation signal,
said transmitter transmits the voicemail message over the second wireless network in response thereto, and
said receiver receives the voicemail message at the first telephone for annunciation at the first telephone.

20. The device according to claim 19 wherein
said coupling detector further detects a re-establishment of the coupling between the first telephone and the device while the second telephone is routed to said voicemail server, and
said router re-couples the first telephone to the second telephone in response thereto.
